(19) United States
(12) Patent Application Publication
(10) Pub. No.: US 2020/0114922 A1
(43) Pub. Date: Apr. 16, 2020

(54) VEHICLE RUNNING CONTROL APPARATUS

(71) Applicant: Toyota Jidosha Kabushiki Kaisha, Toyota-shi Aichi-ken (JP)

(72) Inventor: Jun Tokumitsu, Toyota-shi (JP)

(21) Appl. No.: 16/597,104

(22) Filed: Oct. 9, 2019

(30) Foreign Application Priority Data
Oct. 11, 2018 (JP) 2018-192441

(51) Int. Cl. B60W 30/18; B60W 40/06; B60W 50/00

(52) U.S. Cl. CPC B60W 30/18172; B60W 40/06; B60W 50/00; B60W 2050/0095; B60W 2520/28; B60W 2520/10; B60W 2720/30; B60W 2550/142

(57) ABSTRACT

A control apparatus calculates a road surface warp degree using a sum of a front left vehicle height and a rear right vehicle height, and a sum of a front right vehicle height and a rear left vehicle height. The apparatus obtains slip amounts of drive wheels. When the apparatus determines that a mode selection condition is satisfied, the mode selection condition being a condition to be satisfied when at least a first condition that the road surface warp degree is smaller than a warp threshold is satisfied, the apparatus selects, based on the road surface warp degree and at least one of the slip amounts, one of control modes, as an in-use control mode. Each control mode has been set so as to he suitable for each type of the road surfaces. The apparatus control a driving torque according to the in-use control mode.

### CROSS-REFERENCE TO RELATED APPLICATIONS

This application claims priority to Japanese Patent Application No. 2018-192441 filed on Oct. 11, 2018, the entire contents of which are hereby incorporated by reference.

### BACKGROUND

### Technical Field

The present disclosure relates to a vehicle running control apparatus configured to control driving torques applied to drive wheels of a vehicle in accordance with each of control modes, each of which has been set to be suitable/appropriate for a type of road surfaces of a road on which the vehicle is running.

### Description of the Related Art

Conventionally, there has been a known apparatus configured to automatically determine/assume/infer the type of the road surfaces of the road on which the vehicle is running, based on detection values of various sensors, and to let the vehicle run in accordance with the control mode (running/traveling mode) which is suitable for the determined type of the road surfaces.

For example, one of such conventional apparatuses is configured to automatically determine the type of the road surfaces of the road on which the vehicle is running, based on “a difference in height between a left wheel position and a right wheel position, a difference in height between a front wheel position and a rear wheel position, and the like” detected using vehicle height sensors, and based on each of slip amounts/degrees of the wheels. The type of the road surfaces may include an on-road surface and an off-road surface. The on-road surface is a road surface which is leveled to be flat, and the off-road surface is is a road surface which is not leveled and is uneven.

For example, one of the conventional apparatuses determines that the vehicle is running on the off-road surface when the difference in height between the left wheel position and the right wheel position and/or the difference in height between the front wheel position and the rear wheel position are/is great. In addition, the conventional apparatus determines that the vehicle is running on the off-road surface when the slip amount of a certain wheel becomes great. The conventional apparatus switches the control modes (vehicle running modes or vehicle control modes) into a mode suitable/appropriate for an off-road running when it determines that the vehicle is running on the off-road surface. For example, under the mode appropriate for the off-road running, a speed limit is lowered, and/or the vehicle height is made higher (e.g., refer to Japanese Laid Open Patent Application No. 2018-001901).

### SUMMARY

When the vehicle is running on an inclined road having a flat surface (i.e., when the vehicle is climbing up the inclined on-road), the front height of the vehicle is greater than the rear height of the vehicle, and the difference between those two heights is great. Therefore, in this case, the conventional apparatus may erroneously determine that the vehicle is running on the off-road surface, and may change/switch the control modes into the mode appropriate for the off-road running despite that the vehicle is actually running on the on-road surface. In this manner, the conventional apparatus may set the control mode to a mode which is inappropriate for the actual type of the road surfaces.

The present disclosure is made to solve the problem described above. That is, one of the objects of the present disclosure is to provide a vehicle running control apparatus configured to be able to more accurately/properly select a control mode suitable/appropriate for “a type of road surfaces” of a road on which a vehicle is running, as compared with the conventional apparatus.

A running control apparatus (hereinafter, referred to as a “present disclosure apparatus” for some cases) according to the present disclosure is applied to a vehicle (10) having four wheels including a front left wheel (11FL), a front right wheel (11FR), a rear left wheel (11RL), and a rear right wheel (11RR).

The present disclosure apparatus comprises: a front left vehicle height sensor (41FL) configured to detect a front left vehicle height which is a vehicle height at a position corresponding to (or in the vicinity of) the front left wheel; a front right vehicle height sensor (41FR) configured to detect a front right vehicle height which is a vehicle height at a position corresponding to (or in the vicinity of) the front right wheel; a rear left vehicle height sensor (41RL) configured to detect a rear left vehicle height which is a vehicle height at a position corresponding to (or in the vicinity of) the rear left wheel; a rear right vehicle height sensor (41RR) configured to detect a rear right vehicle height which is a vehicle height at a position corresponding to (or in the vicinity of) the rear right wheel; and a control unit (70).

The control unit (70) is configured to: calculate a road surface warp degree (Wp) which is an absolute value of a difference between a first sum and a second sum, the first sum being a sum of the front left vehicle height and the rear right vehicle height, and the second sum being a sum of the front right vehicle height and the rear left vehicle height (road surface warp degree calculation section, step 925); obtain/calculate slip amounts (Aslip), each of which is a slip amount of each of drive wheels among the four wheels (slip amount obtaining section, 40, step 940); select, as an in-use control mode, one of predetermined control modes each of which corresponds to (or has been determined so as to be suitable for) a type of road surfaces, based on the road surface warp degree and at least one of the slip amounts of the drive wheels, when the control unit determines that a mode selection condition is satisfied (step 925), the mode selection condition being a condition to be satisfied when at least a first condition that the road surface warp degree is equal to or smaller than a road surface warp degree threshold is satisfied (mode selection section, step 950, step 955); and control driving torques applied to the drive wheels in accordance with the (selected) in-use control mode (drive wheels control section, 50, 21a, 30, step 1030).

As described later in detail, the road surface warp degree (Wp) is relatively small when the vehicle is running on a relatively flat road surface (e.g., the on-road surface, the loose-rock road surface, or the mud-sand road surface). In contrast, the road surface warp degree (Wp) is relatively large when the vehicle is running on a road surface having large ups and downs (significantly uneven road surface) such as the mogul road surface and the rock road surface. In other words, the road surface warp degree (Wp) tends to become larger as the ups and downs are greater. Therefore, the road surface warp degree (Wp) is an effective parameter (indicative value) to discriminate the type of the road surfaces in terms of the ups and downs of the road on which the vehicle is running.

Meanwhile, it is not possible to determine what the road surface of the road on which the vehicle is running is, the on-road surface, the loose-rock road surface, or the mud-sand road surface, based solely on the road surface warp degree (Wp). Because, as described above, the road surface warp degree (Wp) is relatively small when the vehicle is running on the relatively flat surface which includes any one of the on-road surface, the loose-rock road surface, and the mud-sand road surface. Accordingly, it is not possible to select, as the in-use control mode, “one of the control modes” which is suitable/appropriate for the type of the road surfaces of the road on which the vehicle is running, based solely on the road surface warp degree (Wp).

In view of the above, the present disclosure apparatus uses not only the road surface warp degree (Wp) but also the slip amount (Aslip) to determine the in-use control mode.

The slip amount (Aslip) is: a relatively small value when the vehicle is running on the on-road surface which is relatively flat; a middle value when the vehicle is running on the loose-rock road surface which is relatively flat; and a relatively large value when the vehicle is running on the mud-sand road surface which is relatively flat.

Therefore, the slip amount (Aslip) is an effective parameter (indicative value) to discriminate the type of the road surfaces in terms of a friction coefficient (roughness) of the road surface of the road on which the vehicle is running.

Accordingly, the present disclosure apparatus can more accurately/properly select, as the in-use control mode, one of the control modes, each of which has been determined in advance so as to be suitable/appropriate for the type of road surfaces of the road.

Meanwhile, when the road surface warp degree is larger than a predetermined road surface warp degree threshold, it is reasonable to infer that the ups and downs of the road surface is very large. On the other hand, when the ups and downs of the road surface is very large, at least one of the wheels (drive wheels) may be apart from (or may not be in contact with) the road surface. If this happens, the slip amount of that wheel (drive wheel) which is apart from the road surface cannot be accurately obtained.

For the above reason, in the present disclosure apparatus, the control unit is configured to select, as the in-use control mode, one of the control modes, based on the road surface warp degree and one of the slip amounts, when the control unit determines that a mode selection condition is satisfied. The mode selection condition is a condition to be satisfied at least when “a first condition that the road surface warp degree is equal to or smaller than the road surface warp degree threshold” is satisfied.

Therefore, the present disclosure apparatus can lower the possibility of selecting an inappropriate control mode, as the in-use control mode.

In one embodiment of the present disclosure apparatus, the control unit is configured to determine that the mode selection condition is satisfied when a second condition, in addition to the first condition, is satisfied, the second condition being a condition to be satisfied when no brake force is applied to any of the drive wheels (step 930).

When the brake force is applied to a certain drive wheel, the slip amount of that certain drive wheel is affected by the brake force. Thus, when the brake force is applied to that certain drive wheel, the obtained slip amount of that certain drive wheel may not be a value which corresponds to the friction coefficient between the road surface and the certain drive wheel (i.e., roughness of the road surface).

In view of the above, the control unit of the above embodiment determines that the mode selection condition is satisfied when “the second condition that no brake force is applied to any of the drive wheels” is satisfied, in addition to the first condition. Furthermore, when the control unit determines that the mode selection condition is satisfied, the control unit selects, as the in-use control mode, one of the control modes, based on the road surface warp degree and one of the slip amounts. Accordingly, the embodiment can more greatly lower/decrease the possibility of selecting an inappropriate control mode, as the in-use control mode.

In one embodiment of the present disclosure apparatus, the control unit is configured to: obtain each of the slip amounts of the drive wheels by, inferring/estimating a driving force applied to each of the drive wheels based on a torque generated by a driving source (21) of the vehicle; obtaining a reference wheel speed (Vwc) of each of the drive wheels based on the inferred driving force; and obtaining each one (Aslip) of the slip amounts of a certain drive wheel based on the reference wheel speed (Vwc) of the certain drive wheel and an actual wheel speed (Vw) of the certain drive wheel (step 940); and determine that the mode selection condition is satisfied when a third condition, in addition to the first condition and the second condition, is satisfied, the third condition being a condition to be satisfied when the vehicle is running straight.

When the vehicle is not running straight (i.e., when the vehicle is turning), the driving forces (driving torques) applied to the left and right drive wheels are different from each other. In this case, the driving forces (driving torques) applied to the left and right drive wheels cannot be accurately inferred/obtained based on the torque which the driving source (21) generates. Thus, the reference wheel speed (Vwc) used to obtain the slip amount cannot be accurately inferred/obtained. Consequently, when the vehicle is not running straight, the obtained slip amount may not be the value which corresponds to the friction coefficient between the road surface and the certain drive wheel (i.e., roughness of the road surface).

In view of the above, the control unit in the above embodiment determines that the mode selection condition is satisfied when the third condition, in addition to the first condition and the second condition, is satisfied, the third condition being the condition to be satisfied when the vehicle is running straight. Furthermore, when the control unit determines that the mode selection condition is satisfied, the control unit selects, as the in-use control mode, one of the control modes, based on the road surface warp degree and the slip amount. Accordingly, the embodiment can much more greatly lower/decrease the possibility of selecting an inappropriate control mode, as the in-use control mode.

One embodiment of the present disclosure apparatus comprises: a speed detecting unit (70, 40FL, 40FR, 40RL, 40RR) configured to detect information on a speed (V) of the vehicle; and an inclination obtaining unit (70, 42) configured to obtaining information on an inclination/gradient (Inc) of the road surface of the road on which the vehicle is running.

The control unit (70) is configured to determine the in-use control mode further based on the speed of the vehicle and the inclination, when the control unit determines that the mode selection condition is satisfied (step 950, step 955).

For example, when the speed of the vehicle is high, the possibility that the vehicle is running on a road surface having the large ups and downs is lower than when the speed of the vehicle is low. Therefore, one of the control mode may be selected as the in-use control mode further based on the speed of the vehicle. In addition, “the control mode to be selected as the in-use control mode for a certain type of the road surfaces with the large inclination” may be different from “the control mode to be selected as the in-use control mode for that certain type of the road surfaces with small inclination”, in order to improve the travel/trip capability of the vehicle. For this reason, one of the control modes may be selected as the in-use control mode further based on the inclination of the road surface. Accordingly, the above embodiment can select, as the in-use control mode, the control mode which is more suitable for the running/traveling of the vehicle.

In one embodiment of the present disclosure apparatus, the control unit is configured to: control the driving forces applied to the drive wheels in accordance with the in-use control mode, by, when at least one of the slip amounts of the drive wheels is larger than a predetermined slip amount threshold (Thslip) which varies depending on the in-use control mode, decreasing one of the driving forces applied to the drive wheel whose slip amount is larger than the predetermined slip amount threshold in such a manner that the slip amount larger than the predetermined slip amount threshold becomes equal to or smaller than the predetermined slip amount threshold (step 1030); and select, as the in-use control mode, one of the control modes, by, when determining the mode selection condition is unsatisfied, automatically selecting, as the in-use control mode, one particular control mode of the control modes regardless of any one of the road surface warp degree and the slip amounts, the one particular control mode having the smallest slip amount threshold among the control modes (step 965).

In the above embodiment, the driving force applied to the drive wheel whose slip amount exceeds the predetermined slip amount threshold is decreased. In addition, when it is determined that the mode selection condition is unsatisfied, “the one particular control mode” having the smallest slip amount threshold among the control modes is automatically selected as the in-use control mode, regardless of any one of the road surface warp degree and the slip amounts. Therefore, when the mode selection condition is unsatisfied (in other words, when the appropriate control mode cannot be selected as the in-use control mode), the slip amount threshold is set to the smallest value among the slip amount thresholds. Accordingly, the slip amount cannot be excessively large regardless of the type of the road surfaces. Thus, the vehicle can run more stably.

In the above descriptions, in order to facilitate understanding of the present disclosure and its embodiments, reference symbols and others used in describing the embodiments below are enclosed in parentheses and assigned to each of the features corresponding to the embodiments. However, each of the features of the present disclosure should not be limited to the embodiment as defined by the reference symbols and others. Other objects, other features, and accompanying advantages of the present disclosure and the embodiments can be readily understood from descriptions of the embodiments provided below referring to the accompanying drawings.

### BRIEF DESCRIPTION OF THE DRAWINGS

FIG. 1 is a schematic diagram of a vehicle equipped with a vehicle running control apparatus (control apparatus) according to an embodiment of the present disclosure.

FIG. 2 is a perspective schematic diagram illustrating some elements of the vehicle and a road surface.

FIG. 3 is a table describing contents of a traction control which the embodiment carries out.

FIG. 4 is a graph showing a relationship between a control mode and a slip amount threshold.

FIG. 5 illustrates a first map of the embodiment,

FIG. 6 Illustrates a second map of the embodiment.

FIG. 7 illustrates a third map of the embodiment.

FIG. 8 illustrates a fourth map of the embodiment.

FIG. 9 is a flowchart showing a routine executed by a running control ECU of the embodiment.

FIG. 10 is a flowchart showing a routine executed by the running control ECU of the embodiment.

FIG. 11 illustrates a map used for controlling an engine of the embodiment.

### DETAILED DESCRIPTION

### (Configuration)

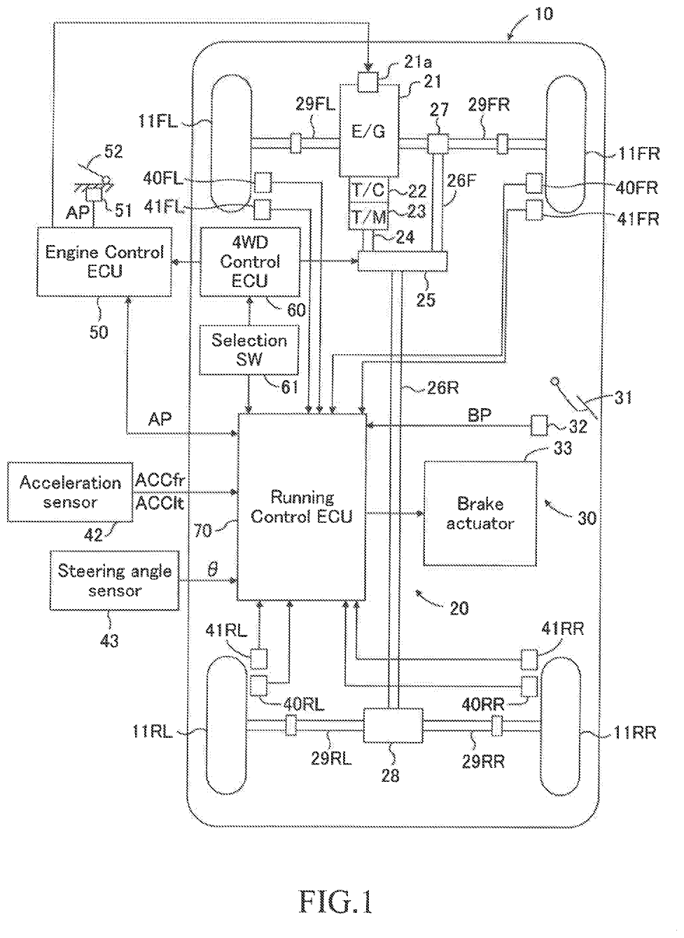

As shown in FIG. 1, a vehicle running control apparatus (hereinafter, referred to as “a present implementation apparatus” in some cases) according to an embodiment of the present disclosure is installed in a vehicle 10. The vehicle 10 comprises a front left wheel 11FL, a front right wheel 11FR, a rear left wheel 11RL, and a rear right wheel 11RR. Furthermore, the vehicle 10 comprises a power train 20, a brake apparatus 30, wheel speed sensors 40FL, 40FR, 40RL, 40RR, and vehicle height sensors 41FL, 41FR, 41RL, 41RR.

In the present specification, each of the front left wheel 11FL, the front right wheel 11FR, the rear left wheel 11RL, and the rear right wheel 11RR may sometimes be collectively referred to as “a wheel 11”. Each of the wheel speed sensors 40FL, 40FR, 40RL, and 40RR may sometimes be collectively referred to as “a wheel speed sensor 40”. Each of the vehicle height sensors 41FL, 41FR, 41RL, and 41RR may sometimes be collectively referred to as “a vehicle height sensor 41”. It should be noted that an element having “a symbol with each of denotations of “FL, FR, RL, and RR” added at the end of the element” means an element which corresponds to the front left wheel 11FL, the front right wheel 11FR, the rear left wheel 11RL, and the rear right wheel 11RR, respectively.

The power train 20 comprises an engine 21, a torque converter 22, a transmission 23, an output shaft 24, a transfer gear 25, a front wheel drive shaft 26F, a rear wheel drive shaft 26R, a front differential 27, a rear differential 28, and drive shafts 29FL, 29FR, 29RL, and 29RR. Each of the drive shafts 29FL, 29FR, 29RL, and 29RR may sometimes be collectively referred to as “a drive shaft 29”.

The engine (a driving source) 21 is an ignition-spark electronic fuel injection type internal combustion engine. The engine 21 comprises an engine actuator 21a including a throttle valve actuator and fuel injectors. The engine 21 varies its output power (engine torque) due to a control of the engine actuator 21a.

The transmission 23 is a multi-speed automatic transmission. The transmission 23 is configured to change its gear positions by unillustrated actuators.

The engine torque is transmitted to the output shaft 24 via the torque converter 22 and the transmission 23. The torque transmitted to the output shaft 24 is always transferred to the front wheel drive shaft 26F, and is sometimes transferred to the rear wheel drive shaft 26R when needed, by the transfer gear 25. In other words, the transfer gear 25 can switch over driving states of the vehicle 10 between a 4WD state (four wheel drive state) and 2WD (two wheel drive state).

The front wheel drive shaft 26F is connected to a left drive shaft 29FL and a right drive shaft 29FR, via the front differential 27. The front left wheel 11FL is fixed to the left drive shaft 29FL. The front right wheel 11FR is fixed to the right drive shaft 29FR.

The rear wheel drive shaft 26R is connected to a left drive shaft 29RL and a right drive shaft 29RR, via the rear deferential 28. The rear left wheel 11RL is fixed to the left drive shaft 29RL. The rear right wheel 11RR is fixed to the right drive shaft 29RR.

The brake apparatus 30 includes a brake pedal 31, a brake operation amount sensor 32, and a brake actuator 33.

The brake operation amount sensor 32 is a sensor configured to detect a brake operation amount BP which is an operation amount of the brake pedal 31. The brake operation amount sensor 32 generates a signal indicative of the brake operation amount BP.

The brake actuator 33 is provided in a hydraulic circuit between an unillustrated master cylinder for pressurizing working oil and unillustrated friction brake devices each of which is arranged in each wheel 11. The friction brake device lets a wheel cylinder work using the working oil supplied from the brake actuator 33 so as to press a brake pad against a brake disc, to thereby generate a brake force for each wheel 11.

Each wheel speed sensor 40 (40FL, 40FR, 40RL, and 40RR) is arranged in the vicinity of each corresponding wheel 11 (11FL, 11FR, 11RL, and 11RR). Each wheel speed sensor 40 generates a signal indicative of a rotational speed of the corresponding wheel 11. For example, each wheel speed sensor 40 generates a single pulse signal every time the corresponding wheel 11 rotates by a predetermined angle.

Each vehicle height sensor 41 (41FL, 41FR, 41RL, and 41RR) is arranged at each position corresponding to each wheel 11 (11FL, 11FR, 11RL, and 11RR).

The vehicle height sensor 41FL detects a front left vehicle height hFL which is a vehicle height at a position corresponding to the front left wheel 11FL to generate a signal indicative of the front left vehicle height hFL.

The vehicle height sensor 41FR detects a front right vehicle height hFR which is a vehicle height at a position corresponding to the front right wheel 11FR to generate a signal indicative of the front right vehicle height hFR.

The vehicle height sensor 41RL, detects a rear left vehicle height hRL which is a vehicle height at a position corresponding to the rear left wheel 11RL to generate a signal indicative of the rear left vehicle height hRL.

The vehicle height sensor 41RR detects a rear right vehicle height hRR which is a vehicle height at a position corresponding to the rear right wheel 11RR to generate a signal indicative of the rear right vehicle height hRR.

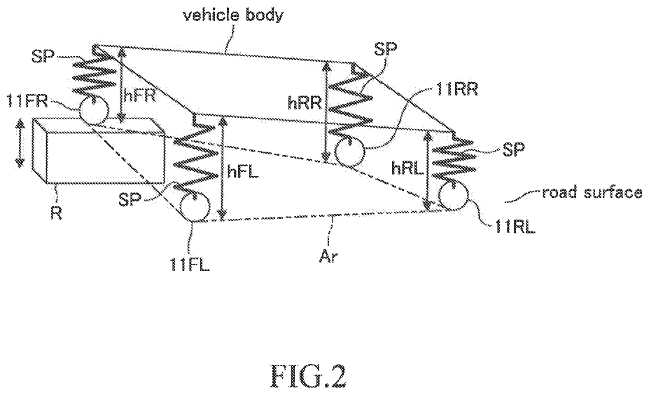

It should be noted that each of the vehicle heights represents a variation amount (or difference) between a specified distance and a predetermined reference distance, wherein the specified distance is a length between an unsprung mass member corresponding to a certain wheel and a sprung mass member located at a position in a vertical (up-and-down) direction of that certain wheel. The predetermined reference distance is, for example, the specified distance observed/measured when the vehicle 10 is not moving (parked) on the horizontal and flat road surface, no one is in the vehicle, and no load is on the vehicle. In other words, as shown in FIG. 2, the vehicle, height is a length which corresponds to a length of a spring member SP provided to each wheel 41.

Furthermore, the vehicle 10 comprises an engine control ECU 50, a 4WD control ECU 60, and a running control ECU 70. The ECU 50, the ECU 60, and the ECU 70 work together to realize functions of the present implementation apparatus. In the present specification, the “ECU” stands for an electric control unit (controller) which includes an electronic circuits having a micro-computer as a main part. The micro-computer includes a CPU, a ROM, a RAM, and an interface 35. The CPU achieves various functions through executing instructions (routines, or programs) stored in the memory (ROM). The ECU 50, the ECU 60, and the ECU 70 are connected to each other via a CAN (controller area network) so as to be able to mutually transmit and receive information among them.

The engine control ECU 50 is connected to an acceleration pedal operation amount sensor 51 and unillustrated other engine control sensors. The acceleration pedal operation amount sensor 51 detects an acceleration pedal operation amount AP to generate a signal indicative of the operation amount AP. The engine control ECU 50 receives signals from those sensors every time a predetermined time elapses. The engine control ECU 50 controls/drives the engine actuators 21a in accordance with the acceleration pedal operation amount AP, the values/amounts detected by the other engine control sensors, a position of a selection switch 61 described later, and instructions transmitted from the running control ECU 70 described later.

The engine control ECU 50 also controls/drives the actuators for the transmission 23 based on at least the acceleration pedal operation amount AP and the vehicle speed V described later, so as to change the gear positions of the transmission 23.

The 4WD control ECU 60 is connected to the selection switch 61. Switch positions of the selection switch 61 are changed/switched by a driver of the vehicle 10. The switch positions of the selection switch 61 includes an H4 position, an H2 position, an N position, and an L4 position.

The 4WD control ECU $0 controls/drives unillustrated actuators for the transfer gear 25 in, response to the position of the selection switch 61 as described later, so as to switch/change over a driving force transmitting states of the transfer gear 25. In some cases, the driving force transmitting state of the transfer gear 25 may be referred to as a transfer range.

More specifically, the 4WD control ECU 60 sets the driving force transmitting state of the transfer gear 25 to the 4WD state, when the position of the selection switch 61 is the H4 position or the L4 position. The 4WD state is a state where the rotational torque of the output shaft 24 (i.e., driving force) is able to be transferred to both of the front wheel drive shaft 26 F and the rear wheel drive shaft 26R.

Note, however, when the position of the selection switch 61 is the L4 position, the 4WD control ECU 60 sets the driving force transmitting state of the transfer gear 25 to a state where the rotational torque of the output shaft 24 is transferred to both of the front wheel drive shaft 26F and the rear wheel drive shaft 26R in a manner described below.
When the position of the selection switch 61 is t he L4 position, a ratio of “a rotational speed of an output shaft of the transfer gear 25” to “a rotational speed of an input shaft of the transfer gear 25 (i.e., a rotational speed of the output shaft 24)” is smaller than when the position of the selection switch 61 is the H4 position: and
when the position of the selection switch 61 is the L4 position, a ratio of “a rotational torque of the output shaft of the transfer gear 25” to “a rotational torque of the input shaft of the transfer gear 25” is greater than when the position of the selection switch 61 is the H4 position.

The rotational torque (drive power) transferred to the front wheel drive shaft 26F is further transferred to the drive shafts 29FL, and 29FR via the front differential 27 so as to rotate the front left and right wheels 11FL, and 11FR. Similarly, the rotational torque (drive power) transferred to the rear wheel drive shaft 26R is further transferred to the drive shafts 29RL, and 29RR via the rear differential 28 so as to rotate the rear left and right wheels 11RL, and 11RR.

The 4WD control ECU 60 sets the driving force transmitting state of the transfer gear 25 to the 2WD state, when the position of the selection switch 61 is the H2 position. The 2WD state is a state where the rotational torque of the output shaft 24 is transferred only to the front wheel drive shaft 26F. If should be noted that the 4WD control ECU 60 may be configured to transfer the rotational torque of the output shaft 24 only to the rear wheel drive shaft 26R, when the position of the selection switch 61 is the H2 position.

The 4WD control ECU 60 sets the driving force transmitting state of the transfer gear 25 to a neutral state, when the position of the selection switch 61 is the N position. The neutral state is a state where the rotational torque of the output shaft 24 is transferred neither to the front wheel drive shaft 26F nor to the rear wheel drive shaft 26R.

The 4WD control ECU 60 is configured to transmit a signal indicative of the position (i.e., one of the H4 position, the H2 position, the N position, and the L4 position) of the selection switch 61 to the engine control ECU 50 and the running control ECU 70.

The running control ECU 70 is connected to the brake operation amount sensor 32, the wheel speed sensor 40, the vehicle height sensor 41, an acceleration sensor 42, and a steering angle sensor 43. The running control ECU 70 receives signals from those sensors every time a predetermined time elapses.

The acceleration sensor 42 is fixed to a vehicle body of the vehicle 10. The acceleration sensor 42 detects an acceleration ACCfr in a front-rear direction of the vehicle body and an acceleration ACCIt in a left-right direction (width direction) of the vehicle body. The acceleration sensor 42 is configured to generate signals indicative of the acceleration ACCfr and the acceleration ACCIt.

The running control ECU 70 repeatedly calculates an inclination/gradient (upslope gradient and downslope gradient) of the road surface in a direction parallel to the front-rear direction of the vehicle (i.e., in a moving direction of the vehicle 10) based on the received front-rear direction acceleration ACCfr, every time a predetermined time elapses.

The running control ECU 70 repeatedly calculates an inclination/gradient of the road surface in a direction parallel to the left-right direction of the vehicle 10 (i.e., in a vehicle width direction) based on the received left-right direction acceleration ACCIt, every time the predetermined time elapses.

The steering angle sensor 43 detects a steering angle θ of an unillustrated steering, wheel to generate a signal indicative of the steering angle θ. The running control ECU 70 repeatedly determines whether or not the vehicle 10 is running straight based on the received steering angle θ, every time the predetermined time elapses.

The running control ECU 70 repeatedly calculates a wheel speed Vw of each wheel 11 based on the signals generated by the respective wheel speed sensor 40, every time the predetermined time elapses. The running control ECU 70 repeatedly calculates the vehicle speed V of the vehicle 10 based on the four of the wheel speeds Vw, every time the predetermined time elapses. For example, the running control ECU 70 calculates, as the vehicle speed V, an average of two of the wheel speeds that include neither the highest wheel speed nor the lowest wheel speed among the four of the wheel speeds.

(Operation in Accordance with In-Use Control Mode)

The vehicle 10 runs on various road surfaces including the followings. Especially, when the vehicle 10 is running under/with the 4WD state, the vehicle has a high probability of running on one of the following road surfaces.

(R1) On-road surface: surface of a paved road

(R2) Loose-rock road surface: road surface having at least a part covered with relatively small rocks

(R3) Mud-sand road surface; road surface covered with mud and/or sand

(R4) Mogul road surface: road surface having at least a part covered with relatively small rocks similar to the loose-rock road surface, but having larger ups and downs as compared to the loose-rock road surface

(R5) Rock road surface: road surface having at least a part covered with large rocks and having larger ups and downs as compared to the mogul road surface

The present implementation apparatus selects one of the control modes, as an in-use control mode, in accordance with the road surface (of the road) on which the vehicle 10 is running, according to methods described later.

Meanwhile, the present implementation apparatus is configured to carry out a traction control (hereinafter, referred to as “a TR control”) for controlling the driving force of the drive wheels in such a manner that any of the slip amounts of the drive wheels is kept smaller than a predetermined amount (hereinafter, referred to as “a slip amount threshold Thslip” which will be described later). The present implementation apparatus is configured to change contents of the TR control in accordance with the in-use control mode. In addition, the present implementation apparatus is configured to change the driving force transmitting states of the transfer gear 25 in accordance with the in-use control mode.

More specifically, a maximum magnitude of the slip amount of the drive wheel (in other words, the slip amount threshold Thslip) permissible for a stable running of the vehicle 10 differs depending on “a road surface roughness (i.e., the type of the road surfaces)”. Furthermore, even when the road surface roughness remains the same, the slip amount threshold Thslip may be varied in accordance with the inclination/gradient of the road surface (inclination angle, or angle of the gradient) as described later. In view of the above, the present implementation apparatus is configured to change (set) the slip amount threshold Thslip used for the TR control in accordance with the in-use control mode. The present implementation apparatus is configured to apply the braking force to the drive wheel when the slip amount of the drive wheel exceeds the slip amount threshold Thslip to control the driving force (driving torque) applied to that drive wheel. Furthermore, the present implementation apparatus is configured to control a change rate of the engine torque generated by the engine 21 in accordance with the in-use control mode so as to control the driving force (driving torque) applied to the drive wheels, as described later.

As shown in FIG, 3, the present implementation apparatus is configured to use five types of the control modes, including a normal mode, a mud-sand mode, a loose-rock mode, a mogul mode, and a rock mode.

The normal mode is suitable for a case where the vehicle 10 is running on the on-road surface.

The mud-sand mode is suitable for a case where the vehicle 10 is running on the mud-sand road surface.

The loose-rock mode is suitable for a case where the vehicle 10 is running on the loose-rock road surface.

The mogul mode is suitable for a case where the vehicle 10 is running on the mogul road surface.

The rock mode is suitable for a case where the vehicle 10 is running on the rock road surface.

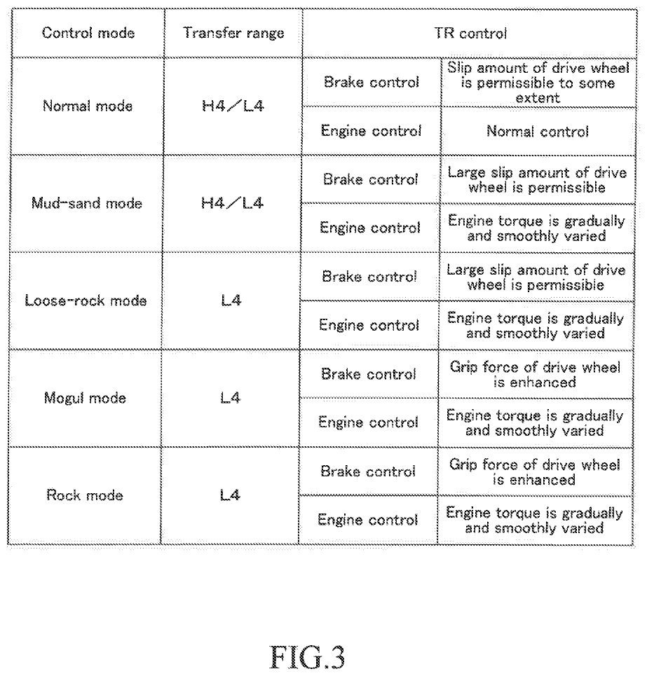

The present implementation apparatus is configured to set the driving force transmitting state of the transfer gear 25 (i.e., a transfer range) as shown in FIG.3, in accordance with, the in-use control mode. In FIG. 3, “H4” indicates an H4 state which is the driving force transmitting state of the transfer gear 25 realized when the position of the selection switch 61 is the H4 position. In FIG. 3, “L4” indicates an L4 state which is the driving force transmitting state of the transfer gear 25 realized when the position of the selection switch 61 is the L4 position. In FIG. 3, “H4/L4” indicates a state where either one of the H4 state and the L4 state is selected based on the vehicle speed V. In this state, the H4 state is realized when the vehicle speed is equal to or higher than a predetermined switching over speed, and the L4 state is realized when the vehicle speed is lower than the predetermined switching over speed.

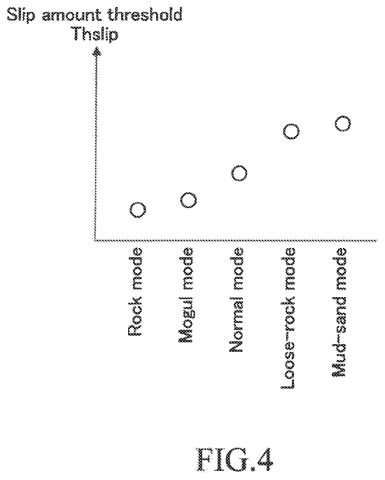

The present implementation apparatus is configured to set/determine the slip amount threshold Thslip in accordance with the in-use control mode, as shown in FIG. 4. The relationship between the in-use control mode and the slip amount threshold Thslip shown in FIG. 4 has been stored in the ROM of the running control ECU 70.

The followings are clearly understood from FIG. 4.

The slip amount threshold Thslip for the mud-sand mode is the largest among the slip amount thresholds.

The slip amount threshold Thslip for the loose-rock mode is smaller than the slip amount threshold Thslip for the mud-sand mode.

The slip amount threshold Thslip for the normal mode is smaller than the slip amount threshold Thslip for the loose-rock mode.

The slip amount threshold Thslip for the mogul mode is smaller than the slip amount threshold Thslip for the normal mode.

The slip amount threshold Thslip for the rock mode is smaller than the slip amount threshold Thslip for the mogul mode, and is the smallest among the slip amount thresholds.

In other words, the descending order of the permissible slip amount for the drive wheels (i.e., the maximum slip amount for the drive wheels which does not cause the vehicle 10 to run unstably due to the slip of the drive wheels) is:

the slip amount threshold Thslip for the mud-sand mode;

the slip amount threshold Thslip for the loose-rock mode;

the slip amount threshold Thslip for the normal mode;

the slip amount threshold Thslip for the mogul mode; and

the slip amount threshold Thslip for the rock mode.

For example, when the vehicle is running on the mud-sand road surface, the vehicle may run without applying the brake force to any of the drive wheels even if the slip amount of the drive wheels becomes relatively large. For this reason, the slip amount threshold Thslip for the mud-sand mode has been set to be a relatively large value.

Meanwhile, when the vehicle is running on the rock road surface, the excessive slip of any of the drive wheels may degrade a travel/trip capability (off-road capability, in this case) of the vehicle 10. For this reason, the slip amount threshold Thslip for the rock mode has been set to be a relatively small value. Accordingly, whereas the grip force of the drive wheels for the road surface is relatively small under the mud-sand mode, the grip force of the drive wheels for the road surface is relatively large under the rock mode.

### (Method for Selecting the In-Use Control Mode)

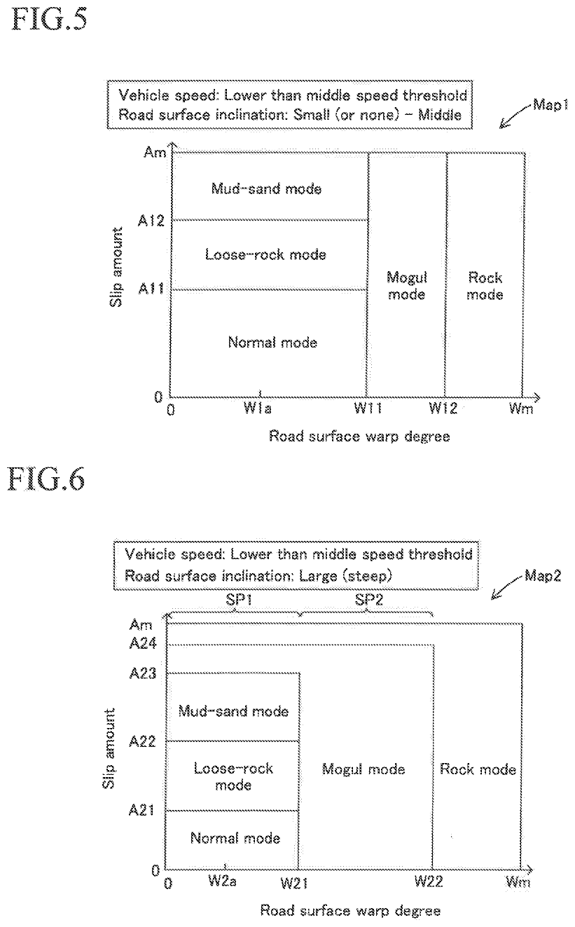

The present implementation apparatus (specifically, the running control. ECU 70) utilizes four maps (look-up tables) shown in FIGS. 5 to 8 to select, as the in-use control mode, one of the control modes which is suitable for the road surface (road surface condition) on which the vehicle 10 is running among the above mentioned five control modes.

The four maps include a first map Map1, a second map Map2, a third map Map3, and a fourth map Map 4, and have been stored in the ROM of the running control ECU 70. In some cases, the first map Map1, the second map Map2, the third map Map3, and the fourth map Map 4 are collectively referred to as “mode selection maps Map”.

Each of the mode selection maps Map defines a relationship between each of the above mentioned five control modes and “a road surface warp degree Wp and a slip amount Aslip” described below. In other words, each of the mode selection maps Map is a look-up table which requires “the road surface warp degree Wp and the slip amount Aslip” as arguments to determine the in-use control mode. In addition, the running control ECU 70 selects one of the mode selection maps Map for determining the in-use control mode, based on the vehicle speed V and the road surface inclination Inc (i.e., the gradient of the road surface). Hereinafter, the one of the mode selection maps Map used to determine the in-use control mode may be referred to as “a control executing map Mapex” in some cases.

### <Calculation of the Road Surface Warp Degree Wp>

The road surface warp degree Wp is calculated by applying “the vehicle heights hFL, hFR, hRL, and hRR” obtained based on the signals from vehicle height sensor 41 to an equation (1) described below. The road surface warp degree Wp is an absolute value of a difference between a first sum and a second sum. The first sum is a sum (hFL+hRR) of one pair of wheel heights (hFL, hRR) of the diagonally positioned wheels. The second sum is a sum (hFR+hRL) of the other one pair of wheel heights (hFR, hRL) of the diagonally positioned wheels.

Road surface warp degree Wp=|(hFL+hRR)−(hFR+hRL)| (1)

As shown in FIG. 2, each wheel 11 is supported by the vehicle body of the vehicle 10 through a spring member (suspension) SP. Therefore, the vehicle heights hFL, hFR, hRL, and hRR vary depending on the condition of the road surface on which the vehicle 10 is present. For example, both of the vehicle height hFR and the vehicle height hRL are smaller and both of the vehicle height hFL and the vehicle height hRR are larger when the front right wheel 11FR is on (runs over) a rock R positioned on a flat surface road with no gradient/inclination, as compared with when the all of the wheels is on the flat surface road with no gradient/inclination. Therefore, since the sum (hFL+hRR) of the vehicle height hFL and the vehicle height hRR is larger than the sum (hFR+hRL) of the vehicle height hFR and the vehicle height hRL, the road surface warp degree Wp is large in this case. As understood from this example, the road surface warp degree Wp has a strong relationship with “a distortion degree (twisted degree)” of a specific road surface area Ar surrounded/defined by four points at which the four wheels 11 contact with the road surface.

The inventor of the present application found out that the road surface warp degree Wp becomes larger in the order of the on-road surface, the mud-sand road surface, the loose-rock road surface, the mogul road surface, and the rock road surface. That is, the road surface warp degree Wp is the smallest when the vehicle 10 is running on the on-road surface. The road surface warp degree Wp is the largest when the vehicle 10 is running on the rock road surface. In other words, the road surface warp degree Wp for the rock road surface is the largest, and thus, larger than the road surface warp degree Wp for the mogul road surface. The road surface warp degree Wp for the mogul road surface is larger than the road surface warp degree Wp for the loose-rock road surface. The road surface warp degree Wp for the loose-rock road surface is larger than the road surface warp degree Wp for the mud-sand road surface. The road surface warp degree Wp for the mud-sand road surface is larger than the road surface warp degree Wp for the on-road surface which is the smallest. As understood from the above, the road surface warp degree Wp has a relatively strong relationship with “the roughness of the road surface”, and therefore, is a parameter (index value) which can indicate the “the roughness of the road surface” with high accuracy.

The relationship between the road surface warp degree Wp and the roughness of the road surface is not susceptible to the road surface inclination Inc. This is because, for example, when the vehicle is running on (climbing up) a flat and inclined on-road surface, both of the vehicle height hFL and the vehicle height hFR become larger, and both of the vehicle height hRL and the vehicle height hRR becomes smaller, so that the road surface warp degree Wp becomes nearly zero (“0”).

### <Calculation of Slip Amount Aslip>

The slip amount Aslip is calculated using an equation (2) below, for each of the drive wheels.

Slip amount Aslip=Wheel speed Vw−Reference wheel speed Vwc (2)

The Reference wheel speed Vwc is a theoretical wheel speed of each of the drive wheels of when the vehicle 10 is running on a predetermined road surface and a predetermined driving torque is being applied to each of the drive shafts 29. The predetermined road surface is, for example, a flat and dried asphalt road surface (e.g., the on-road surface) with no inclination.

When the driving force transmitting state of the transfer gear 25 is set at the 4WD state, the transfer gear 25 distributes “the engine torque transferred to the output shaft 24 via the torque converter 22 and the transmission 23” to the front wheel drive shaft 26F and the rear wheel drive shaft 26R. The torque transferred to the front wheel drive shaft 26F is further distributed/transferred to the drive shaft 29FL, and the drive shaft 29FR via the front differential 27. Similarly, the torque transferred to the rear wheel drive shaft 26R is further distributed/transferred to the drive shaft 29F and the drive shaft 29RR via the rear differential 27.

The engine control ECU 50 has information on the current engine torque and the current gear position of the transmission 23. The 4WD control ECU 60 has information on the driving force transmitting state of the transfer gear 25. The running control ECU 70 receive such information from the engine control ECU 50 and the 4WD control ECU 60, via the CAN. Therefore, the running control ECU 70 can obtain/infer the each of the driving forces (driving torques) for each of the drive wheels based on the received information through calculation or using a look-up table stored in the ROM, when the vehicle 10 is running straight. Furthermore, the running control ECU 70 obtains the reference wheel speed Vwc for each of the wheels 11 based on the obtained driving forces (driving torques) through calculation or using a look.-up table stored in the ROM.

The slip amount Aslip has a relatively strong relationship with a friction coefficient μ between the each of the drive wheels and the road surface. The friction coefficient μ has a relatively strong relationship with the roughness of the road surface. Accordingly, the slip amount Aslip is a parameter (index value) which can indicate the “the roughness of the road surface” with certain accuracy.

As understood from the above, there is the relatively strong relationship between the road surface warp degree Wp and the roughness of the road surface, and there is the relatively strong relationship between the slip amount Aslip and the roughness of the road surface. Thus, the roughness of the road surface can be determined by using (based on) both of the road surface warp degree Wp and the slip amount Aslip with relatively high accuracy. In other words, the determination as to what the road surface on which the vehicle 10 is running is among the on-road surface, the mud-sand road surface, the loose-rock road surface, mogul road surface, and the rock road surface, can be made with relatively high accuracy through the use of the road surface warp degree Wp and the slip amount Aslip. For this reason, each of the mode selection maps Map is configured to use “the road surface warp degree Wp and the slip amount Aslip” as its arguments (to determine the in-use control mode). Each of the mode selection maps Map will next be described in more detail.

### <First Map Map1 (FIG. 5)>

The first map Map1 is selected as the control executing map Mapex, when the vehicle 10 is running at a speed lower than a middle speed threshold (e.g., 30 km/h) and on a road surface with the road surface inclination Inc equal to or smaller than a middle inclination threshold (i.e., road surface with no or small inclination/gradient).

Hereinafter, assuming that the torque applied to the drive wheel is kept at a certain unchanged torque, the slip amounts Aslip for various cases are expressed as follows.

Aslip-n: the slip amount Aslip when the vehicle 10 is running on the on-road surface.

Aslip-Ir: the slip amount Aslip when the vehicle 10 is running on the loose-rock surface.

Aslip-ms: the slip amount Aslip when the vehicle 10 is running on the mud-sand surface.

Generally, when the road surface warp degree Wp is an arbitrary value W1a within a range smaller than a predetermined value W11, the following relationship is satisfied.

Aslip-n<Aslip-Ir<Aslip-ms

Therefore, when the first map Map1 is used as the control executing map Mapex and the road surface warp degree Wp is the arbitrary value W1a within the range smaller than the predetermined value W11, the in-use control mode is determined as follows.

The in-use control mode is the normal mode when the slip amount Aslip is small (i.e., 0≤Aslip<A11).

The in-use control mode is the loose-rock mode when the slip amount Aslip is medium (i.e., A11≤Aslip<A12).

The in-use control mode is the mud-sand mode when the slip amount Aslip is large (i.e., A12≤Aslip<Am).

When the first map Map1 is used as the control executing map Mapex and the road surface warp degree Wp is equal to or larger than the predetermined value W11 and smaller than a predetermined value W12, it can be determined that the road surface on which the vehicle 10 is running is the mogul road surface (road surface having large ups and downs). In addition, when the first map Map1 is used as the control executing map Mapex and the road surface warp degree Wp is equal to or larger than the predetermined value W12, it can be determined that the road surface on which the vehicle 10 is running is the rock road surface (road surface having ups and downs larger than those of the mogul road surface). Accordingly, when the first map Map1 is used as the control executing map Mapex, the in-use control mode is determined as follows, regardless of the slip amount Aslip.

The in-use control mode is the mogul mode when the road surface warp degree Wp is equal to or larger than the predetermined value W11 and smaller than, the predetermined value W12 (i.e., W11≤Wp<W12).

The in-use control mode is the rock mode when the road surface warp degree Wp is equal to or larger than the predetermined value W12 (i.e., W12≤Wp<Wm).

### <Second Map Map2 (FIG. 6)>

The second map Map2 is selected as the control executing map Mapex, when the vehicle 10 is running at a speed lower than the middle speed threshold (e.g., 30 km/h) and on a road surface with the road surface inclination Inc larger than the middle inclination threshold (i.e., road surface with a large gradient or a relatively steep slope). This is because, in the case where the vehicle 10 is running at a relatively low speed (speed lower than the middle speed threshold), the in-use control mode to be selected when the road surface inclination is large may be somewhat different from the in-use control mode to be selected when the road surface inclination is small, in order to improve the travel/trip capability of the vehicle 10.

For example, assuming that the road surface on which the vehicle 10 is running is the mud-sand road surface, and if the in-use control mode is set to the mud-sand mode, the slip amount threshold Thslip is relatively large. However, when the vehicle 10 is running at a relatively low speed on a steep slope and mud-sand road surface, the vehicle may not be able to climb up that slope (and thus, the travel/trip capability of the vehicle 10 may be degraded), since the slip amount may become too large due to the relatively large slip amount threshold Thslip.

In view of the above, as described above, when the vehicle 10 is running relatively slowly and on the road surface with the relatively large road surface inclination Inc, the second map Map 2 is selected as the control executing map Mapex. In this case, when the road surface warp degree Wp is an arbitrary value W2a within a range smaller than a predetermined value W21 which is smaller than the predetermined value W11 (i.e., W21<W11), the in-use control mode is determined as follows (refer to an area Sp1 shown in FIG. 6).

The in-use control mode is the normal mode when the slip amount Aslip is s a (i.e., 0≤Aslip<A21<A11).

The in-use control mode is the loose-rock mode when the slip amount Aslip is medium (i.e., A21≤Aslip<A22<A12).

The in-use control mode is the mud-sand mode when the slip amount Aslip is large (i.e., A22≤Aslip<A23).

The in-use control mode is the mogul mode when the slip amount Aslip is further large (i.e., A23≤Aslip<A24).

The in-use control mode is the rock mode when the slip amount Aslip is extremely large (i.e., A24≤Aslip<Am).

Furthermore, when the second map Map2 is used as the control executing map Mapex and the road surface warp degree Wp is an arbitrary value within a range from the predetermined value W21 to a predetermined value W22 which is equal to the predetermined value W12 (i.e., W22=W12), the in-use control mode is determined as follows (refer to an area Sp2 shown in FIG. 6).

The in-use control mode is the mogul mode when the slip amount Aslip is smaller than a relatively large value A24 (i.e., Aslip<A24).

The in-use control mode is the rock mode when the slip amount Aslip is extremely large (i.e. A24≤Aslip<Am).

It should be noted that, when the second map Map2 is used as the control executing map Mapex and the road surface warp degree Wp is equal to or larger than the predetermined value W22 which is equal to the predetermined value W12 (i.e., W22=W12), the rock mode is selected as the in-use control mode regardless of the slip amount Aslip.

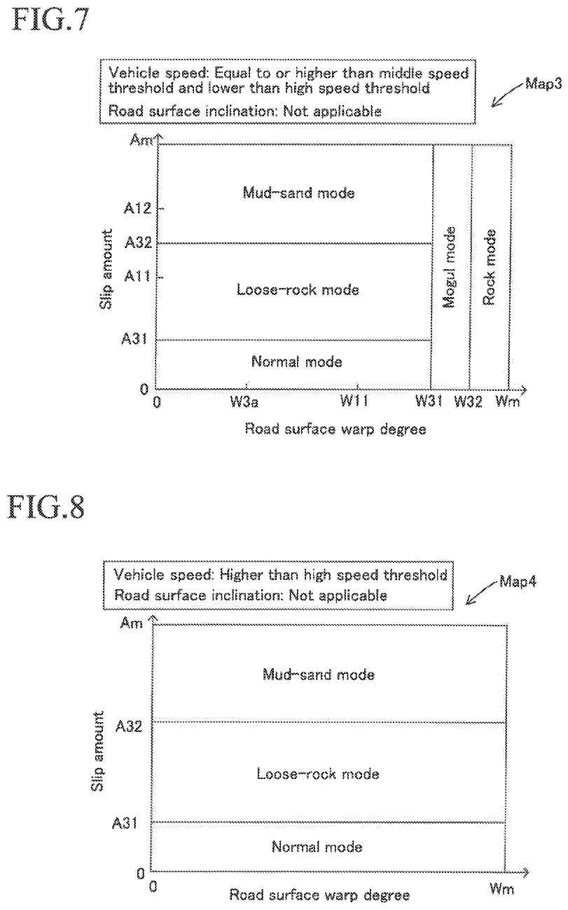

### <Third Map Map3 (FIG. 7)>

The third map Map3 is selected as the control executing map Mapex, when the vehicle 10 is running at a speed which is equal to or higher than the middle speed threshold (e.g., 30 km/h) and is lower than a high speed threshold (e.g., 70 km/h), regardless of the road surface inclination Inc.

When the third map Map3 is selected as the control executing map Mapex and the road surface warp degree Wp is an arbitrary value W3a within a range smaller than a predetermined value W31, the in-use control mode is determined as follows.

The in-use control mode is the normal mode when the slip amount Aslip is small (i.e., 0≤Aslip<A3<A11).

The in-use control mode is the loose-rock mode when the slip amount Aslip is medium (i.e., A31≤Aslip<A32<A12, A32>A11).

The in-use control mode is the mud-sand mode when the slip amount Aslip is large (i.e., A32≤Aslip<Am).

It should be noted that the predetermined value W31 has been set to a value larger than the predetermined value W11. This is because, the road surface on which the vehicle 10 is running is unlikely to be the mogul road surface or the rock surface when the vehicle 10 is running at the speed which is equal to or higher than the middle speed threshold and is lower than the high speed threshold.

Furthermore, when the third map Map3 is selected as the control executing map Mapex and the road surface warp degree Wp is larger than the predetermined value W31, the in-use control mode is determined regardless of the slip amount Aslip, as follows. The reason for this is the same as when the first map Map1 is selected as the control executing map Mapex, as described above.

The in-use control mode is the mogul mode when the road surface warp degree Wp is equal to or larger than a predetermined value W31 and smaller than a predetermined value W32 (W31≤Wp<W32, W31>W11, and W32>W12).

The in-use control mode is the rock mode when the road surface warp degree Wp is equal to or larger than the predetermined value W32 (i.e., W32≤Wp<Wm).

### <Fourth Map Map4 (FIG. 8)>

The fourth map Map4 is selected as the control executing map Mapex, when the vehicle 10 is running at a speed higher than the high speed threshold (e.g., 70 km/h), regardless of the road surface inclination Inc. When the vehicle 10 is running at a speed higher than the high speed threshold, the road surface on which the vehicle 10 is running is very unlikely to be the mogul road surface or the rock surface.

Therefore, when the fourth map Map4 is selected as the control executing map Mapex, the in-use control mode is determined regardless of the slip amount Aslip, as follows,

The in-use control mode is the normal mode when the slip amount Aslip is small (i.e. 0≤Aslip<A31).

The in-use control mode is the loose-rock mode when the slip amount Aslip is medium (i.e., A3≤Aslip<A32).

The in-use control mode is the mud-sand mode when the slip amount Aslip is large (i.e., A32≤Aslip<Am).

As described above, the running control ECU 70 is configured to select the control executing map Mapex out of the four mode selection maps Map based on the vehicle speed V and the road surface inclination Inc. Furthermore, the running control ECU 70 is configured to apply, to the selected control executing map Mapex, the road surface warp degree Wp and the slip amount Aslip as the arguments, so as to select one of the control mode which is most suitable/appropriate for the actual road surface among a plurality of the control modes.

It should be noted that the running control ECU 70 is configured to employ/use, as the argument for the mode selection maps Map, the maximum value Aslipmax which is the largest among the tow or four slip amounts of the drive wheels calculated according to the equation (2) described above.

### (Actual Operation)

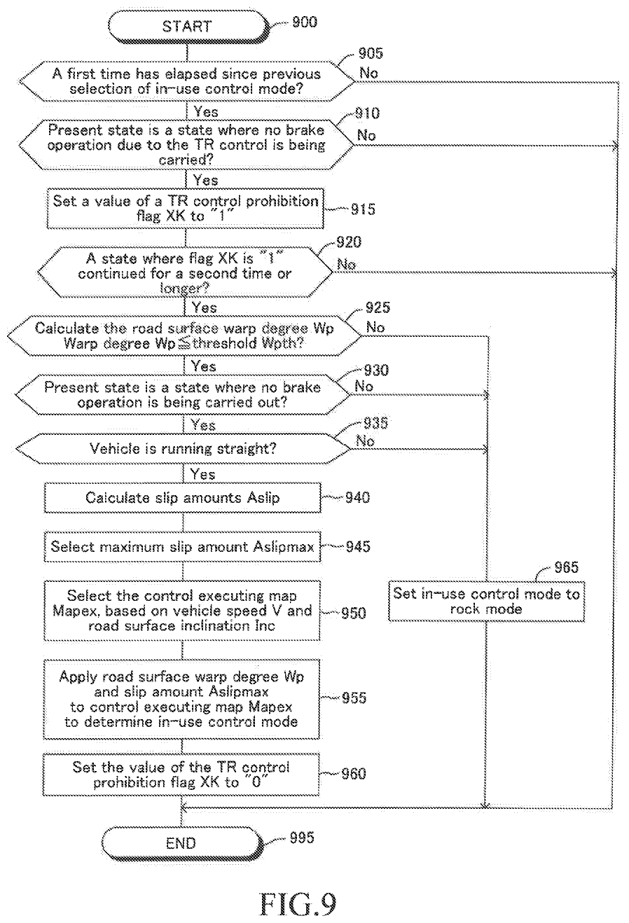

The CPU (hereinafter, simply referred to as the “CPU”) of the running control ECU 70 is configured to repeatedly execute a routine (control mode selection routine) illustrated by a flowchart shown in FIG. 9 every time a predetermined time elapses, while an unillustrated ignition key switch of the vehicle 10 is positioned at an ON position. It should be noted that the CPU initially sets the in-use control mode to the rock mode when the position of the ignition key switch is changed from an OFF position to the ON position.

At a certain time point, the CPU starts executing processes from step 900 to proceed to step 905, at which the CPU determines whether or not a predetermined first time has elapsed since a process for selecting the in-use control mode (i.e., process at step 955 described later) was previously carried out. It should be noted that the process for selecting the in-use control mode includes the above described process for initially setting the in-use control mode to the rock mode.

When the first time has elapsed since the process for selecting the in-use control mode was previously carried out, the CPU makes a “Yes” determination at step 905 to proceed to step 910. At step 910, the CPU determines whether or not a state of the present time point is a state where no brake operation due to the TR control (i.e., applying brake force using the brake actuator 33) is being carried out to any of the wheels (drive wheels) 11. The brake operation due to the TR control is carried out in “the brake control based on the TR control” which will be described later.

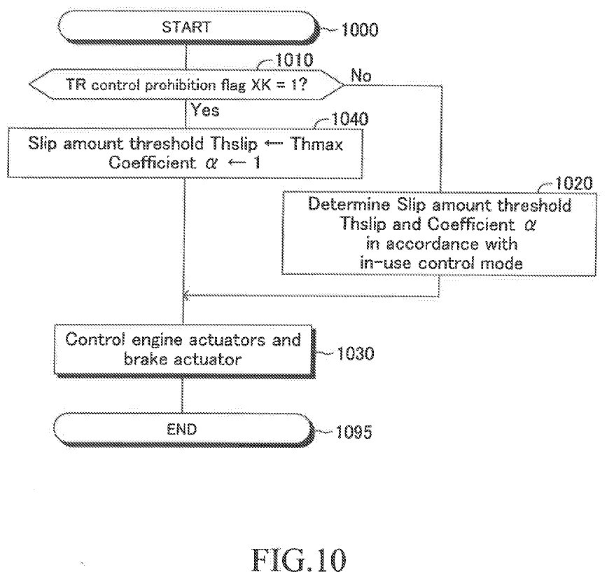

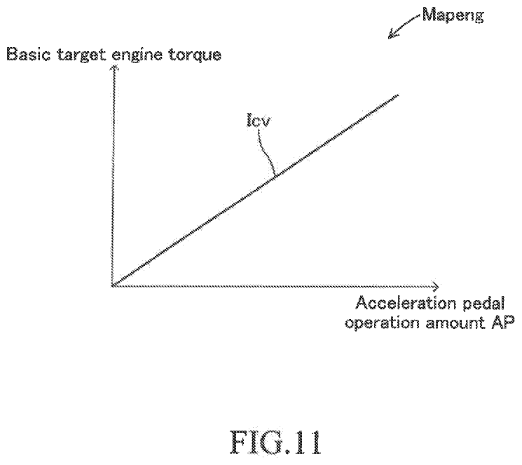

Assuming that the present time point is the state where no brake operation due to the TR control is being carried out to any of the wheels (drive wheels) 11, the CPU makes a “Yes” determination at step 910 to proceed to step 915, at which the CPU sets a value of a TR control prohibition flag XK to “1”. When the value of the TR control prohibition flag XK is “1”, “the brake operation due to the TR control and an engine control due to the TR control” are substantially prohibited as described later (refer to FIG. 10).

Subsequently, the CPU proceeds to step 920 to determine whether or not a state where the value of the TR control prohibition flag XK is “1” has continued for a predetermined second time or longer. When the state where the value of the TR control prohibition flag XK is “1” has continued for the predetermined second time or longer, the CPU makes a “Yes” determination at step 920 to proceed to step 925.

At step 925, the CPU calculates/obtains the road surface warp degree Wp by applying the values each of which is detected by the vehicle height sensor 41 (i.e., the vehicle height hFL, the vehicle height hRR, the vehicle height hFR, and the vehicle height hRL) to the above equation (1). Furthermore, the CPU determines whether or not the calculated road surface warp degree Wp is equal to or smaller than a road surface warp degree threshold Wpth stored in the ROM.

When the road surface warp degree Wp is larger than the road surface warp degree threshold Wpth, the accuracy (reliability) of the slip amount Aslip calculated based on the above equation (2) is low. For example, when the rock R shown in FIG. 2 is very large/high, the vehicle height hFR and the vehicle height hRL become small, and the front left wheel 11FL and/or the rear right wheel 11RR may apart from the road surface. If this happens, since there is no friction between the wheel which has been apart from the road surface and the road surface, the accuracy (reliability) of the slip amount Aslip to be calculated at step 940 described later, based on the above equation (2), becomes low. The decrease in the accuracy (reliability) of the slip amount Aslip lowers the accuracy (reliability) of the in-use control mode which is selected based on the slip amount Aslip.

When the road surface warp degree Wp is equal to or smaller than the road surface warp degree threshold Wpth, the CPU makes a “Yes” determination at step 925 to proceed to step 930, at which the CPU determines whether or not the state of the present time point is a state where no brake operation (i.e., applying brake force using the brake actuator 33) is being carried out to any of the drive wheels. The brake operation includes not only the above described brake operation due to the TR control but also brake operation carried out when the brake pedal 31 is depressed and/or when a collision avoidance control is performed. When the CPU is transmitting an operation/command signal to the brake actuator 33, the CPU determines that the brake operation is being carried out, at step 930.

When a brake operation is being carried out to any drive wheel 11, “the driving force (driving torque) applied to the drive wheel” which is required to calculate the reference wheel speed Vwc cannot be calculated accurately. Thus, in this case, the accuracy (reliability) of the slip amount Aslip to be calculated based on the above equation (2) at step 955 described later is low. This degrades the reliability of the in-use control mode which is selected using the control executing map Mapex and the slip amount Aslip.

When the state of the present time point is the state where no brake operation is being carried out to any of the drive wheels, the CPU makes a “Yes” determination at step 930 to proceed to step 935, at which the CPU determines whether or not the vehicle 10 is running straight by determining whether or not a magnitude of the steering angle θ is smaller than a steering angle threshold θth.

When the vehicle 10 is running straight, the torque transferred to the left drive shaft 29FL and the torque transferred to the right drive shaft 29FR, both via the front differential 27 from the front wheel drive shaft 26F, are equal to each other. Similarly, when the vehicle 10 is running straight, the torque transferred to the left drive shaft 29RL and the torque transferred to the right drive shaft 29RR, both via the rear differential 28 from the rear wheel drive shaft 26R, are equal to each other. Accordingly, when the vehicle 10 is running straight, the CPU can calculate/obtain the driving force (driving torque) applied to each of the wheels 11 (drive wheels) accurately, using the information on “the current engine torque and the current gear position” and the information on “the current driving force transmitting state of the transfer gear 25”.

In contrast, when the vehicle 10 is turning (i.e., is not running straight), a difference between the wheel speed of the inner wheel and the wheel speed of the outer wheel becomes large. Therefore, the torque transferred to the left drive shaft 29FL and the torque transferred to the right drive shaft 29FR are different from each other, and the torque transferred to the left drive shaft 29RL and the torque transferred to the right drive shaft 29RR are different from each other. In this case, the CPU cannot infer/obtain the torque transferred to each of the driving shafts 29. Accordingly, when the vehicle 10 is turning (i.e., is not running straight), the CPU cannot accurately calculate/obtain “the driving force (driving torque) applied to each of the wheels 11 (drive wheels)” which is required to calculate the reference wheel speed Vwc accurately. This causes a degradation in accuracy (reliability) of the slip amount Aslip to be calculated based on the above mentioned equation (2), at step 955 described later.

When it is determined that the vehicle 10 is running straight at step 935 (that is, the determining conditions of steps 925, 930, and 935 are all satisfied), it can be determined that a predetermined mode selection condition is satisfied. In this case, the CPU makes a “Yes” determination at step 935 to execute processes of steps 940 to 960 described below in this order, and then proceeds to step 995 to terminate the present routine tentatively.

Step 940: The CPU calculates the slip amounts (Aslip), each corresponding to each of the wheels (drive wheels) based on the equation (2) as described above.

Step 945: The CPU selects the maximum/largest slip amount among two or four of the slip amounts calculated at step 940 as the slip amount Aslipmax.

Step 950: The CPU calculates/obtains the vehicle speed V based on the signals received from the vehicle wheel speed sensors 40, and calculates/obtains the road surface inclination Inc based on “the acceleration ACCfr and the acceleration ACCIt” detected by the acceleration sensor 42. In addition, the CPU selects one out of the four mode selection maps Map, as the control executing map Mapex, based on the calculated “vehicle speed V and road surface inclination Inc”, as described above.

Step 955: The CPU applies “the road surface warp degree Wp and the slip amount Aslipmax” to the control executing map Mapex to determine the in-use control mode.

It should be noted that, when the vehicle 10 is running on the rock road surface and the second map Map2 has been selected as the control executing map Mapex, the loose-rock mode may be selected as the in-use control mode if the minimum (smallest) value among a plurality of the slip amounts of the drive wheels is used as the argument for the control executing map Mapex. If this happens, since a large slip amount of the drive wheel is allowed due to the relatively large slip amount threshold Thslip, the travel/trip capability of the vehicle 10 may be greatly degraded.

To the contrary, in the present embodiment, the maximum (largest) value among a plurality of the slip amounts of the drive wheels is used as the argument for the control executing map Mapex. Accordingly, under the above described scene, either one of the rock mode and the mogul mode is likely to be selected as the in-use control mode using the second map Map 2, and therefore, the large slip amount of the drive wheel are not allowed. Accordingly, it is unlikely that the travel/trip capability of the vehicle 10 is degraded.

Step 960: The CPU sets the value of the TR control prohibition flag XK to “0”.

Meanwhile, if the CPU makes a “No” determination at any one of the steps 905, 910, and 920, the CPU directly proceeds to step 995 to terminate the present routine tentatively. In this case, the in-use control mode remains unchanged.

Furthermore, if the CPU makes a “No” determination at any one of the steps 925, 930, and 935 (i.e., when the mode selection condition is not satisfied), the CPU proceeds to step 965 to set the in-use control mode to the rock mode. Thereafter, the CPU proceeds to step 995 to terminate the present routine tentatively.

In addition, the CPU is configured to repeatedly execute a routine (driving control execution routine) illustrated by a flowchart shown in FIG. 10 every time the predetermined time elapses, while the ignition key switch of the vehicle 10 is positioned at the ON position.

At a certain time point, the CPU starts executing processes from step 1000 to proceed to step 1010, at which the CPU determines whether or not the value of the TR control prohibition flag XK is “1”. When the value of the value of the TR control prohibition flag XK is not “1”, the CPU makes a “No” determination at step 1010 to proceed to step 1020, at which the CPU executes the following processes.

The CPU sets the slip amount threshold Thslip to a value corresponding to the current in-use control mode (the in-use control mode at the present time point). More specifically, the CPU read out the slip amount threshold Thslip corresponding to the current in-use control mode from the ROM. As shown in FIG, 4, the slip amount threshold Thslip has been set to become smaller in the order of the mud-sand mode, the loose-rock mode, the normal mode, the mogul mode, and the rock mode. That is, the slip amount threshold Thslip for the mud-sand mode is the largest, and the slip amount threshold Thslip for the rock mode is the smallest.

The CPU sets a coefficient a used in an equation (3) which will be described later to a value corresponding to the current in-use control mode. More specifically, the CPU sets the coefficient α to 1 when the current in-use control mode is the normal mode. The CPU sets the coefficient α to “a predetermined value larger than 0 and smaller than 1”, when the current in-use control mode is any one of “the mud-sand mode, the loose-rock mode, the mogul mode, and the rock mode”.

Subsequently, the CPU proceeds to step 1030 to execute processes for controlling the engine actuators 21a and the brake actuator 33 as described later. The processes includes processes based on “the brake control due to the TR control and the engine control due to the TR control”.

On the other hand, when the value of the TR control prohibition flag XK is “1”, the CPU makes a “Yes” determination at step 1010 to proceed to step 1040, at which the CPU executes the following processes.

The CPU sets the slip amount threshold Thslip to an extremely large value Thmax which the slip amount Aslip never reaches while the vehicle 10 is running.

The CPU sets the coefficient a used in the equation (3) which will be described later to “1”.

Thereafter, the CPU proceeds to step 1030, and then, proceeds to step 1095 to terminate the present routine tentatively. The processes at step 1030 (the processes based on the brake control due to the TR control and the processes based on the engine control due to the TR control) will next be described.

### <Brake Control Due to TR Control>

The CPU determines whether or not each of the slip amounts Aslip of the wheels (drive wheels) 11 is larger than the slip amount threshold Thslip. When any particular slip amounts Aslip of the certain wheel (drive wheel) is larger than the slip amount threshold Thslip, the CPU controls the brake actuator 33 to apply the brake force to that certain wheel. When the slip amounts Aslip of that certain wheel becomes equal to or smaller than the slip amount threshold Thslip (or a amount smaller than the slip amount threshold Thslip by a certain positive value) due to the applied brake force to that certain wheel, the CPU stops applying the brake force to that certain wheel. This control using the brake force to decrease the slip amount is referred to as the brake control due to the TR control. It should be noted that the brake control due to the TR control is substantially prohibited when the slip amount threshold Thslip has been set to the extremely large value Thmax, because the slip amount Aslip never becomes equal to or larger than the extremely large value Thmax.

### <Engine Control Due to TR Control>

The CPU controls the engine torque in accordance with the in-use control mode. More specifically, the CPU calculates a target value (that is, a target engine torque Etgt(n)) which the engine 21 is required to generate, according to the equation (3) below.

Etgt(n)=(1−α)·Etgt(n−1)+α·Icv(n) (3)

In the equation (3), Etgt(n−1) is an target engine torque at a time point the predetermined time before (i.e., previous calculation time point), and Icv(n) is a basic target engine torque Icy obtained by applying “the current acceleration pedal operation amount AP (amount AP at the present time point)” to the engine control map Mapeng shown in FIG. 11.

As described above, when the in-use control mode is the normal mode, the coefficient α is set to “1”. In this case, the target engine torque Etgt(n) is equal to the basic target engine torque Icv(n). In contrast, when the in-use control mode is either one of “the mud-sand mode, the loose-rock mode, the mogul mode, and the rock mode”, the coefficient a is set to “the value larger than 0 and smaller than 1”. In this case, the target engine torque Etgt(n) is a value (blurred value) obtained by time smoothing the basic target engine torque Icv. In other words, the target engine torque Etgt(n) becomes a value which follows the basic target engine torque Icv but varies more gradually than the basic target engine torque Icv.

The CPU transmits the calculated target engine torque Etgt(n) to the engine control ECU 50. The engine control ECU 50 controls the engine using the engine actuators 21a in such a manner that the actual engine torque becomes equal to the received target engine torque Etgt(n). Therefore, when the in-use control mode is either one of “the mud-sand mode, the loose-rock mode, the mogul mode, and the rock mode”, the engine torque generated by the engine 21 more gradually vanes as compared with the case where the in-use control mode is the normal mode. This engine control based on the thus calculated target engine torque Etgt(n) is referred to as the engine control due to the TR control.

It should be noted that any of the brake control due to the TRC control and the engine control due to the TRC control is a control for controlling the driving force for the drive wheels (the driving torque applied to the drive wheels to rotate the drive wheels), and therefore, is also referred to as a driving force control.

The present disclosure has been described using the embodiment of the present disclosure, however, the present disclosure should not be limited to the above described embodiment, and can employ various modifications within the scope of the present subject matter.

For example, the present disclosure can be applied to a hybrid vehicle having both of an internal combustion engine and an electric motor as driving sources of the vehicle, or to a vehicle (such as an electric vehicle or a fuel cell vehicle) having an electric motor only as a driving source of the vehicle.

The arguments for the mode selection maps Map may include not only “the road surface warp degree Wp and the slip amount Aslip” but also “either the vehicle speed V or the road surface inclination Inc”. Alternatively, the arguments for the mode selection maps Map may include all of the road surface warp degree Wp, the slip amount Aslip, the vehicle speed V, and the road surface inclination Inc.

The number of the mode selection maps Map is not necessarily four, but a plural number other than four. Furthermore, the control modes may include a mode other than the above described five modes, or may include two or more of the above described five modes.

The mode selection maps Map may be maps, each configured to have nothing, to do with the vehicle speed V or the road surface inclination Inc, and have “the road surface warp degree Wp and the slip amount Aslip” as the arguments. In this example, only one mode selection map Map is prepared.

The running control ECU 70 may be configured to determine the in-use control mode by using the equations or functions using the arguments which the lookup tables (mode selection maps Map) use, instead of using the look-up tables.

The vehicle 10 may be equipped with torque sensors, each of which detects a torque of each drive shaft 29 (that is, driving torque applied to each of the drive wheels). The running control ECU 70 may be configured to obtain the reference wheel speed Vwc for each of the drive wheels based on the torque detected by each of the torque sensor. In this case, steps 930 and 935 may be omitted. That is, the mode selection condition may be a condition which is to be satisfied when the road surface warp degree Wp is equal to or smaller than the road surface warp degree threshold Wpth. Furthermore, in this case, the step 935 may be omitted. In other words, the mode selection condition may be a condition which is to be satisfied when the road surface warp degree Wp is equal to or smaller than the road surface warp degree threshold Wpth and the no brake operation is carried out for the any of the drive wheels. In addition, in this case, step 930 may be omitted. That is, the mode selection condition may be a condition which is to be satisfied when the road surface warp degree Wp is equal to or smaller than the road surface warp degree threshold Wpth and the vehicle 10 runs straight.

Furthermore, the running control ECU 70 may be configured to set the coefficient α used in an equation (3) to a value which differs for each of the in-use control modes. Moreover, the engine control map Mapeng shown in FIG. 11 may be modified so that the basic target engine torque Icv is obtained for each of the in-use control modes.

The running control ECU 70 may be configured to calculate the slip amount Aslip according to the following equation (2A).

Slip amount Aslip=(Wheel speed Vw−Reference wheel speed Vwc)/Vwc (2A)

The running control ECU 70 may use a temporal average of the road surface warp degree Wp (a value obtained by averaging the road surface warp degree Wp with respect to time) as the argument for the control executing map Mapex. Similarly, the running control ECU 70 may use a temporal average of the slip amount (Aslip) (a value obtained by averaging the slip amount Aslip with respect to time) as the argument for the control executing map Mapex. Furthermore, the running control ECU 70 may use an average of the slip amounts (Aslip) of the drive wheels as the argument for the control executing map Mapex.

Any one of the slip amounts Aslip of the all drive wheels may be used as the argument for the control executing map Mapex. Alternatively, an average of the slip amounts Aslip of a plurality of the drive wheels may be used as the argument for the control executing map Mapex.

What is claimed is:

1. A running control apparatus applied to a vehicle having four wheels including a front left wheel, a front right wheel, a rear left wheel, and a rear right wheel, comprising:
a front left vehicle height sensor configured to detect a front left vehicle height which is a vehicle height at a position corresponding to said front left wheel;
a front right vehicle height sensor configured to detect a front right vehicle height which is a vehicle height at a position corresponding to said front right wheel;
a rear left vehicle height sensor configured to detect a rear left vehicle height which is a vehicle height at a position corresponding to said rear left wheel;
a rear right vehicle height sensor configured to detect a rear right vehicle height which is a vehicle height at a position corresponding to said rear right wheel; and
a control unit configured to:
calculate a road surface warp degree which is an absolute value of a difference between a first sum and a second sum, said first sum being a sum of said front left vehicle height and said rear right vehicle height, and said second sum being a sum of said front right vehicle height and said rear left vehicle height;
obtain slip amounts, each of which is a slip amount of each of drive wheels among said four wheels:
select, as an in-use control mode, one of predetermined control modes each of which corresponds to a type of road surfaces, based on said road surface warp degree and at least one of said slip amounts of said drive wheels, when said control unit determines that a mode selection condition is satisfied, said mode selection condition being a condition to be satisfied at least when a first condition that said road surface warp degree is equal to or smaller than a road surface warp degree threshold is satisfied; and
control driving torques applied to said drive wheels in accordance with said in-use control mode.

2. The running control apparatus according to claim 1, wherein,
said control unit is configured to determine that said mode selection condition is satisfied when a second condition, in addition to said first condition, is satisfied, said second condition being a condition to be satisfied when no brake force is applied to any of said drive wheels.

3. The running control apparatus according to claim 2, wherein,
said control unit is configured to:
obtain each of said slip amounts of said drive wheels by,
inferring a driving force applied to each of said drive wheels based on a torque generated by a driving source of said vehicle;
obtaining a reference wheel speed of each of said drive wheels based on said inferred driving force; and
obtaining each one of said slip amounts of a certain drive wheel based on said reference wheel speed of said certain drive wheel and an actual wheel speed of said certain drive wheel; and
determine that said mode selection condition is satisfied when a third condition, in addition to said first condition and said second condition, is satisfied, said third condition being a condition to be satisfied when said vehicle is running straight.

4. The running control apparatus according to claim 1 wherein,
said control unit is configured to:
obtain a speed of said vehicle;
obtain a road surface inclination of a road surface on which said vehicle is running; and
determine said in-use control mode further based on said speed of said vehicle and said road surface inclination, when said mode selection condition is determined to be satisfied.

5. The running control apparatus according to claim 2 wherein,
said control unit is configured to:
obtain a speed of said vehicle;
obtain a road surface inclination of a road surface on which said vehicle is running; and
determine said in-use control mode further based on said speed of said vehicle and said road surface inclination, when said mode selection condition is determined to be satisfied.

6. The running control apparatus according to claim 3 wherein,
said control unit is configured to:
obtain a speed of said vehicle;
obtain a road surface inclination of a road surface on which said vehicle is running; and
determine said in-use control mode further based on said speed of said vehicle and said road surface inclination, when said mode selection condition is determined to be satisfied.

7. The running control apparatus according to claim 1 wherein,
said control unit is configured to:
control said driving forces applied to said drive wheels in accordance with said in-use, control mode, by, when at least one of said slip amounts of said drive wheels is larger than a predetermined slip amount threshold which varies depending on said in-use control mode, decreasing one of said driving forces applied to said drive wheel whose slip amount is larger than said predetermined slip amount threshold in such a manner that said slip amount larger than said predetermined slip amount threshold becomes equal to or smaller than said predetermined slip amount threshold; and
select, as said in-use control mode, one of said control modes, by, when determining said mode selection condition is unsatisfied, automatically selecting, as said in-use control mode, one particular control mode of said control modes regardless of any one of said road surface warp degree and said slip amounts, said one particular control mode having the smallest slip amount threshold among said control modes.

8. The running control apparatus according to claim 2 wherein,
said control unit is configured to:
control said driving forces applied to said drive wheels in accordance with said in-use control mode, by, when at least one of said slip amounts of said drive wheels is larger than a predetermined slip amount threshold which varies depending on said in-use control mode, decreasing one of said driving forces applied to said drive wheel whose slip amount is larger than said predetermined slip amount threshold in such a manner that said slip amount larger than said predetermined slip amount threshold becomes equal to or smaller than said predetermined slip amount threshold; and
select, as said in-use control mode, one of said control modes, by, when determining said mode selection condition is unsatisfied, automatically selecting, as said in-use control mode, one particular control mode of said control modes regardless of any one of said road surface warp degree and said slip amounts, said one particular control mode having the smallest slip amount threshold among said control modes.

9. The running control apparatus according to claim 3 wherein,
said control unit is configured to:
control said driving forces applied to said drive wheels in accordance with said in-use control mode, by, when at least one of said slip amounts of said drive wheels is larger than a predetermined slip amount threshold which varies depending on said in-use control mode, decreasing one of said driving forces applied to said drive wheel whose slip amount is larger than said predetermined slip amount threshold in such a manner that said slip amount larger than said predetermined slip amount threshold becomes equal to or smaller than said predetermined slip amount threshold; and
select, as said in-use control mode, one of said control modes, by, when determining said mode selection condition is unsatisfied, automatically selecting, as said in-use control mode, one particular control mode of said control modes regardless of any one of said road surface warp degree and said slip amounts, said one particular control mode having the smallest slip amount threshold among said control modes.

10. The running control apparatus according to claim 4 wherein,
said control unit is configured to:
control said driving forces applied to said drive wheels in accordance with said in-use control mode, by, when at least one of said slip amounts of said drive wheels is larger than a predetermined slip amount threshold which varies depending on said in-use control mode, decreasing one of said driving forces applied to said drive wheel whose slip amount is larger than said predetermined slip amount threshold in such a manner that said slip amount larger than said predetermined slip amount threshold becomes equal to or smaller than said predetermined slip amount threshold; and
select, as said in-use control mode, one of said control modes, by, when determining said mode selection condition is unsatisfied, automatically selecting, as said in-use control mode, one particular control mode of said control modes regardless of any one of said road surface warp degree and said slip amounts, said one particular control mode having the smallest slip amount threshold among said control modes.

11. The running control apparatus according to claim 5 wherein,
said control unit is configured to:
control said driving forces applied to said drive wheels in accordance with said in-use control mode, by, when at least one of said slip amounts of said drive wheels is larger than a predetermined slip amount threshold which varies depending on said in-use control mode, decreasing one of said driving forces applied to said drive wheel whose slip amount is larger than said predetermined slip amount threshold in such a manner that said slip amount larger than said predetermined slip amount threshold becomes equal to or smaller than said predetermined slip amount threshold; and
select, as said in-use control mode, one of said control modes, by, when determining said mode selection condition is unsatisfied, automatically selecting, as said in-use control mode, one particular control mode of said control modes regardless of any one of said road surface warp degree and said slip amounts, said one particular control mode having the smallest slip amount threshold among said control modes.

12. The running control apparatus according to claim 6 wherein,
said control unit is configured to:
control said driving forces applied to said drive wheels in accordance with said in-use control mode, by, when at least one of said slip amounts of said drive wheels is larger than a predetermined slip amount threshold which varies depending on said in-use control mode, decreasing one of said driving forces applied to said drive wheel whose slip amount is larger than said predetermined slip amount threshold in such a manner that said slip amount larger than said predetermined slip amount threshold becomes equal to or smaller than said predetermined slip amount threshold; and
select, as said in-use control mode, one of said control modes, by, when determining said mode selection condition is unsatisfied, automatically selecting, as said in-use control mode, one particular control mode of said control modes regardless of any one of said road surface warp degree and said slip amounts, said one particular control mode having the smallest slip amount threshold among said control modes.
